(19) United States
(12) Patent Application Publication
(10) Pub. No.: US 2026/0238078 A1
(43) Pub. Date: Aug. 13, 2026

(54) CANNED MOTOR FOR ELECTRIC SUBMERSIBLE PUMP

(71) Applicant: Schlumberger Technology Corporation, Sugar Land, TX (US)

(72) Inventors: Raju EKAMBARAM, Singapore (SG); You Cheng JEE, Singapore (SG); Stanislav Konstantinovich IVANOV, Singapore (SG); Maxim Y. RADOV, Singapore (SG)

(21) Appl. No.: 19/645,721

(22) Filed: Apr. 13, 2026

Related U.S. Application Data
(63) Continuation of application No. 18/685,687, filed on Aug. 25, 2022, now Pat. No. 12,603,546.

(30) Foreign Application Priority Data
Aug. 25, 2021 (SG) 10202109299U

(51) Int. Cl. H02K 7/08; H02K 5/16; H02K 15/14; H02K 5/128

(52) U.S. Cl. CPC H02K 7/08; H02K 5/161; H02K 15/14; H02K 5/1285; H02K 7/083

(57) ABSTRACT

A canned motor for a submersible pump system and a method of manufacturing a canned motor are provided. The canned motor includes a plurality of rotor bearings keyed to the can of the canned motor.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. The present application is a continuation application of U.S. Application No. 18/685,687, filed Feb. 22, 2024, which is a National Stage Entry of PCT/US2022/041530, filed Aug. 25, 2022, which claims priority benefit of Singapore Application No. SG 10202109299U, filed Aug. 25, 2021, the entirety of each of which is incorporated by reference herein and should be considered part of this specification.

### BACKGROUND

### Field

The present disclosure generally relates to electric submersible pumps, and more particularly to canned motor architectures.

### Description of the Related Art

Various types of artificial lift equipment and methods are available, for example, electric submersible pumps (ESPs). An ESP includes multiple centrifugal pump stages mounted in series, each stage including a rotating impeller and a stationary diffuser mounted on a shaft, which is coupled to a motor. In use, the motor rotates the shaft, which in turn rotates the impellers within the diffusers. Well fluid flows into the lowest stage and passes through the first impeller, which centrifuges the fluid radially outward such that the fluid gains energy in the form of velocity. Upon exiting the impeller, the fluid flows into the associated diffuser, where fluid velocity is converted to pressure. As the fluid moves through the pump stages, the fluid incrementally gains pressure until the fluid has sufficient energy to travel to the well surface.

### SUMMARY

In some configurations, a motor for a submersible pumping system includes a housing; a canned stator comprising: a lamination stack and stator windings; and a can disposed within a central bore of the lamination stack and disposed adjacent an inner diameter of the lamination stack, an inner diameter of the can comprising at least one keyway; a shaft and rotor sub-assembly comprising: a shaft; at least one rotor disposed about the shaft; and at least one rotor bearing disposed about the shaft, the at least one rotor bearing comprising at least one key configured to engage the keyway of the can when the shaft and rotor sub-assembly is disposed within the canned stator.

The motor can further include encapsulation material disposed between the housing and the can. The at least one rotor bearing can include an upper rotor bearing disposed proximate an upper end of the lamination stack, a lower rotor bearing disposed proximate a lower end of the lamination stack, and at least one intermediate rotor bearing disposed between the upper and lower rotor bearings.

The canned stator can include a sealing mechanism at each axial end of the can to prevent fluid entry into the lamination stack. The sealing mechanism can include at least one port configured to allow wires from the motor to extend therethrough for external connections. The sealing mechanism can include one or more of welding, adhesive(s), elastomeric sealing elements, and metallic sealing elements.

The motor can further include a compensator unit coupled to the motor. The compensator unit includes a compensation bellow. Wires can extend from the motor, within the compensator unit along an outer diameter of the bellow, to a downhole gauge.

In some configurations, a method of manufacturing a motor for a submersible pumping system includes inserting a can into a central bore of a stator, the stator comprising a lamination stack disposed within a housing; and inserting a shaft and rotor sub-assembly into a central bore of the can, the shaft and rotor sub-assembly comprising at least one rotor disposed about a shaft and at least one rotor bearing disposed about the shaft.

The method can further include sealing interfaces between an outer diameter of the lamination stack and an inner diameter of the housing and between an inner diameter of the lamination stack and an outer diameter of the can. The method can include passing wires from the motor, through a sealing mechanism at or near a bottom of the motor, to extend to a downhole gauge.

The method can further include at least partially filling a space between the housing and the can with encapsulation material. The method can include pre-forming at least one keyway along an inner surface of the can prior to assembly with the lamination stack and housing. Alternatively, the method can include forming, e.g., hydroforming, at least one keyway along an inner surface of the can after inserting the can into the central bore of the stator. The method can further include aligning and engaging the keys of the rotor bearings with the keyways in the inner surface of the can.

The at least one rotor bearing can include an upper rotor bearing disposed proximate an upper end of the lamination stack, a lower rotor bearing disposed proximate a lower end of the lamination stack, and at least one intermediate rotor bearing disposed between the upper and lower rotor bearings.

The method can further include coupling a compensator unit to the motor, the compensator unit comprising a compensation bellow. The method can include filling an area outside the bellow with dielectric oil The method can include routing wires from the motor, within the compensator unit along an outer diameter of the bellow, to a downhole gauge. The compensation unit can include communication ports open to the well bore, allowing well fluid to enter an area inside the bellow to provide pressure equalization between the ESP motor and the wellbore.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows a schematic of an electric submersible pump (ESP) system.

FIG. 2A shows a stator.

FIG. 2B shows a can sub-assembly.

FIG. 2C shows examples of cans having a pre-formed keyway and without a pre-formed keyway.

FIG. 3A shows a cross-section of a canned stator, including the stator of FIG. 2A and can of FIG. 2B.

FIG. 3B shows a shaft-rotor sub-assembly.

FIG. 3C shows a cross-section of another example of a canned stator.

FIG. 4A shows an assembled canned motor, including the canned stator of FIG. 3A and shaft-rotor sub-assembly of FIG. 3B.

FIG. 4B shows areas of the canned motor of FIG. 4A filled with encapsulation, clean motor oil, and well fluid.

FIG. 4C shows a variation of an assembled canned motor.

FIG. 4D shows areas of the canned motor of FIG. 4C filled with encapsulation, oil, and well fluid.

FIG. 5A shows a transverse cross-section of the canned motor of FIG. 4A.

FIG. 5B shows a transverse cross-section of the canned motor of FIG. 4C.

FIG. 6 shows a close-up view of a portion of the canned motor of FIG. 4, showing a key of a rotor bearing engaged with a keyway of the can.

FIG. 7A shows a longitudinal cross-sectional view of the canned motor of FIG. 4A, taken along line A-A shown in FIG. 5A.

FIG. 7B shows a longitudinal cross-sectional view of the canned motor of FIG. 4C, taken along line A-A shown in FIG. 5B.

FIG. 8A shows a longitudinal cross-sectional view of the canned motor of FIG. 4A, taken along line B-B shown in FIG. 5A.

FIG. 8B shows a longitudinal cross-sectional view of the canned motor of FIG. 4C, taken along line B-B shown in FIG. 5B.

FIG. 9 shows the canned motor of FIG. 4D coupled to a downhole gauge.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms "up" and "down"; "upper" and "lower"; "top" and "bottom"; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

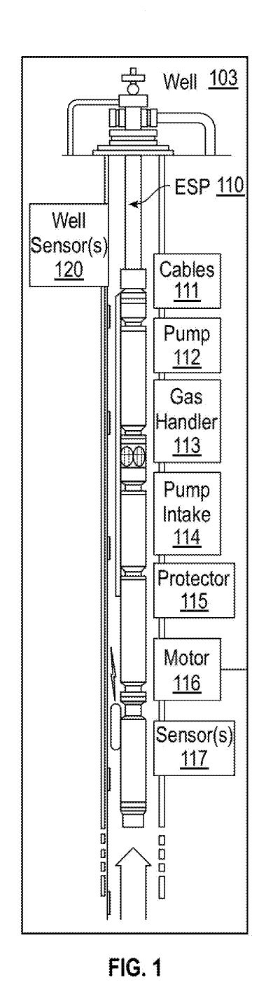

Various types of artificial lift equipment and methods are available, for example, electric submersible pumps (ESP). As shown in the example embodiment of FIG. 1, an ESP 110 typically includes a motor 116, a protector 115, a pump 112, a pump intake 114, and one or more cables 111, which can include an electric power cable. The motor 116 can be powered and controlled by a surface power supply and controller, respectively, via the cables 111. In some configurations, the ESP 110 also includes gas handling features 113 and/or one or more sensors 117 (e.g., for temperature, pressure, current leakage, vibration, etc.). As shown, the well may include one or more well sensors 120.

The pump 112 includes multiple centrifugal pump stages mounted in series within a housing. Each stage includes a rotating impeller and a stationary diffuser. A shaft extends through the pump 112 and is operatively coupled to the motor 116. The shaft can be coupled to the protector 115 (e.g., a shaft of the protector), which in turn can be coupled to the motor 116 (e.g., a shaft of the motor). The impellers are rotationally coupled, e.g., keyed, to the shaft. The diffusers are coupled, e.g., rotationally fixed, to the housing. In use, the motor 116 causes rotation of the shaft (for example, by rotating the protector 115 shaft, which rotates the pump shaft), which in turn rotates the impellers relative to and within the stationary diffusers.

In use, well fluid flows into the first (lowest) stage of the ESP 110 and passes through an impeller, which centrifuges the fluid radially outward such that the fluid gains energy in the form of velocity. Upon exiting the impeller, the fluid makes a sharp turn to enter a diffuser, where the fluid’s velocity is converted to pressure. The fluid then enters the next impeller and diffuser stage to repeat the process. As the fluid passes through the pump stages, the fluid incrementally gains pressure until the fluid has sufficient energy to travel to the well surface.

The motors of submersible pumping systems typically include a stator secured within a tubular housing and a rotor secured to a power transmission shaft that rotates within the stator. The rotor typically is made up of a number of rotor sections, the number of rotor sections depending upon the length and power rating of the motor. The rotor sections are spaced apart from each other, and a rotor bearing assembly is located between each rotor section. Each rotor section is connected to the shaft so that all of the rotor sections rotate as the shaft rotates. The motor can be a permanent magnet synchronous motor or an AC induction motor.

Each rotor bearing assembly within a rotor section acts to support the shaft and to maintain it in proper axial alignment. A rotor bearing assembly comprises a sleeve connected or keyed to the shaft so that the sleeve and shaft rotate together, and a journal (e.g., bearing, bushing) disposed coaxially around the sleeve. The journal may be configured to engage the inner wall of the stator to prevent the journal from rotating and to maintain proper alignment of the shaft.

The present disclosure provides a canned motor, for example for a submersible pumping system, and methods of manufacturing or assembling such a canned motor. The canned motor can include a hermetically sealed stator, which may be encapsulated. In some configurations, canned motors according to the present disclosure include a plurality of rotor bearings, including rotor bearings positioned at intermediate locations along the shaft, for example between rotor sections and between upper and lower ends of the stator. The sealed stator includes a can disposed along and forming an inner diameter or surface of the sealed stator. An inner diameter or surface of the can includes a keyway configured to receive a corresponding key of the rotor bearings.

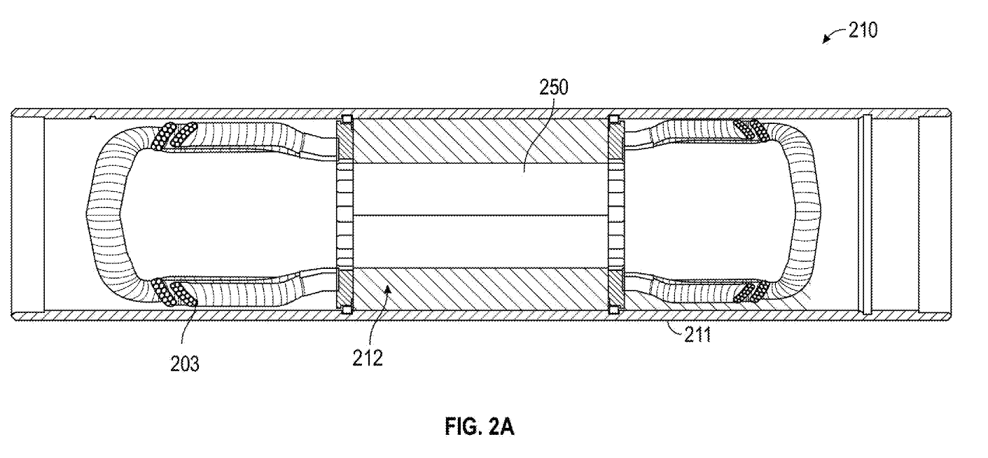

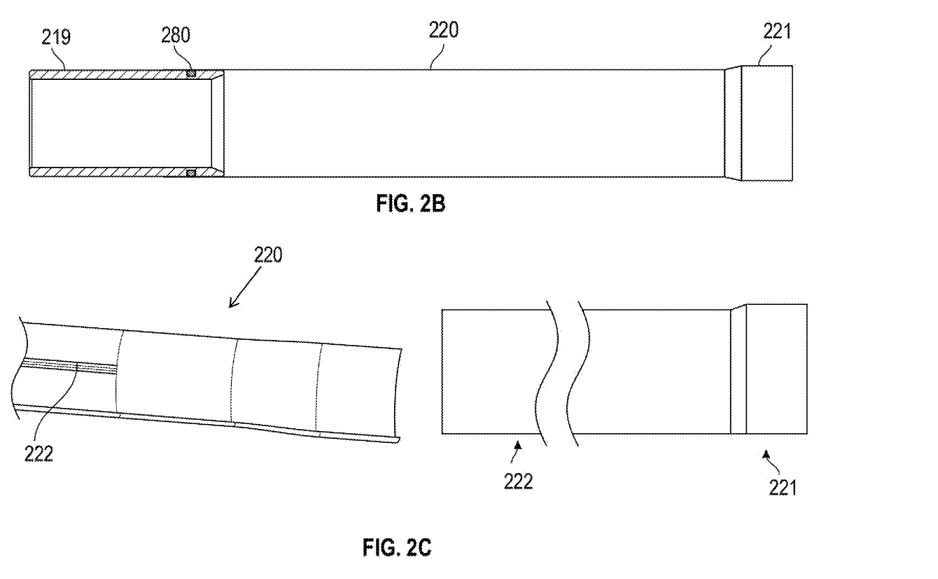

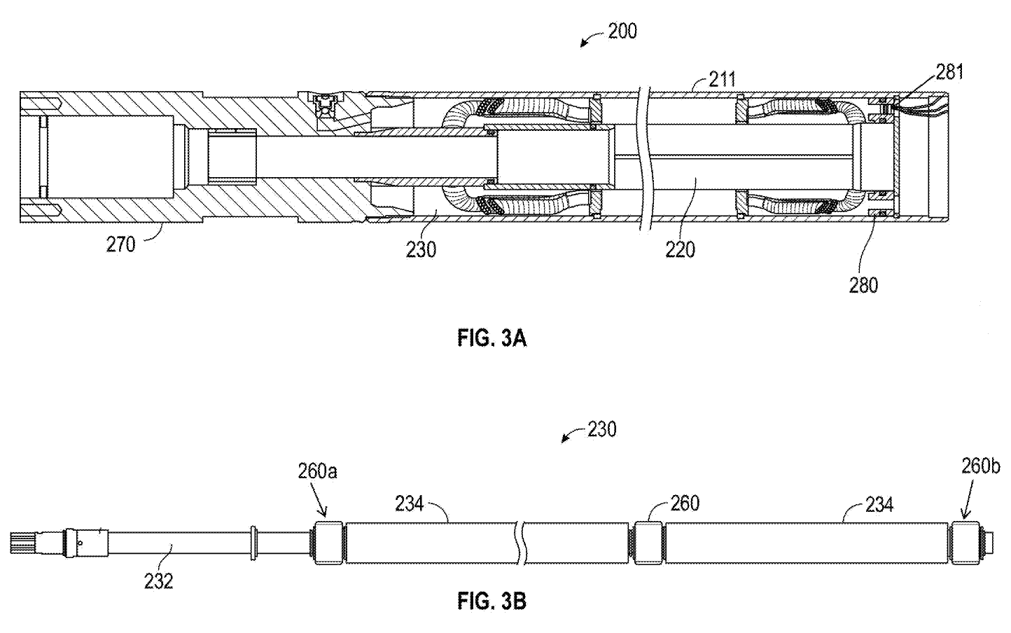

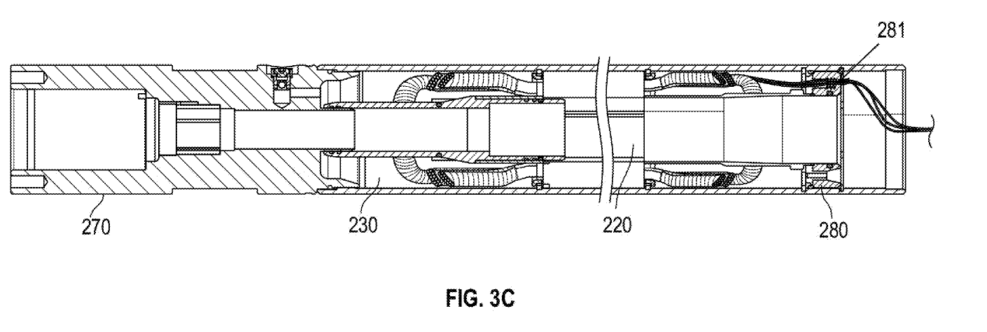

To assemble a canned motor according to the present disclosure, a can sub-assembly 220, shown in FIGS. 2B and 2C, is inserted into a central bore 250 of a wound stator 210, shown in FIG. 2A. An upper end of the can 220 can form a flange end 219. In some configurations, the can 220 includes an expanded lower end 221. The wound stator 210 includes a lamination stack 212, including a plurality of stator laminations 214, disposed within a housing 211. The canned stator 200 can be sealed at or near each end via one or more various sealing mechanisms 280 to prevent fluid entry into the lamination stack 212. For example, interfaces between an outer diameter of the lamination stack 212 and an inner diameter of the housing 211, and between the inner diameter of the lamination stack 212 and an outer diameter of the can 220 can be sealed to form a hermetically sealed canned stator 200, as shown in FIG. 3A. Such sealing can be accomplished via, for example, welding, adhesives, elastomeric and/or metallic sealing elements, some combination thereof, or other appropriate sealing means. Stator windings can extend through slots of the stator laminations 214 and form end coils 203 at the axial ends. As shown in FIG. 3A, available space between the housing 211 and the can 220 can be filled with encapsulation material 230. The hermetically sealed stator 200 is advantageously tolerant to well fluid or water ingress, which improves the reliability of the motor 116.

As shown in, for example, FIG. 6, the can 220 includes a recessed keyway 222. In some configurations, the inner diameter or surface of the stator laminations 214 includes a keyway, and the can 220 follows the profile of the inner surface of the lamination stack 212, including the keyway of the laminations 214, as shown in FIG. 6. The keyway 222 can have various shapes or curvatures (e.g., transverse cross-sectional shapes or curvatures), such as square or circular. The keyway 222 can extend along an entire length or axis of the can 220 or of the stator 200 or lamination stack 212, or may only extend along portions of the length of the stator 200 in the location or area of the rotor bearings 260 when assembled.

The keyway 222 can be pre-formed in the can 220 prior to assembly (e.g., prior to inserting the can 220 into the lamination stack 212) as shown on the left of FIG. 2C. Alternatively, the can 220 may not include a pre-formed keyway 222, as shown on the right of FIG. 2C. The keyway 222 can be formed, e.g., hydroformed, in-situ after the can 220 is assembled into the stator bore 250. Hydroforming can advantageously enable keying of one or more intermediate rotor bearings, which would otherwise be problematic. The design of the present disclosure uses the stator laminations 214 directly as the mold for the hydroforming process of the thin walled can 220. This advantageously eliminates intermediate steps of transferring a hydroformed can into the motor stator, which could damage the can 220. This also advantageously provides an improved fit between the can 220 and the stator.

FIG. 3B shows a shaft-rotor sub-assembly 230. The shaft-rotor sub-assembly 230 includes a shaft 232, one or more rotor sections 234 disposed about the shaft 232, and one or more rotor bearings 260. The rotor sections 234 can be keyed to the shaft 232 via one or more shaft keys 233. As shown, a top rotor bearing 260a can be disposed on top of the rotor (e.g., proximate or adjacent an upper end of an uppermost rotor section 234), a bottom rotor bearing 260b can be disposed at the bottom of the rotor (e.g., proximate or adjacent a lower end of a lowermost rotor section 234), and one or more rotor bearings 260 can be disposed at intermediate locations along the shaft 232 between the top and bottom rotor bearings, for example, between consecutive rotor sections 234.

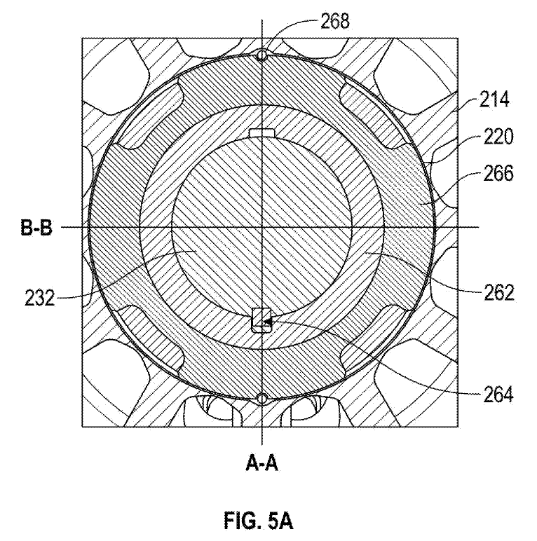

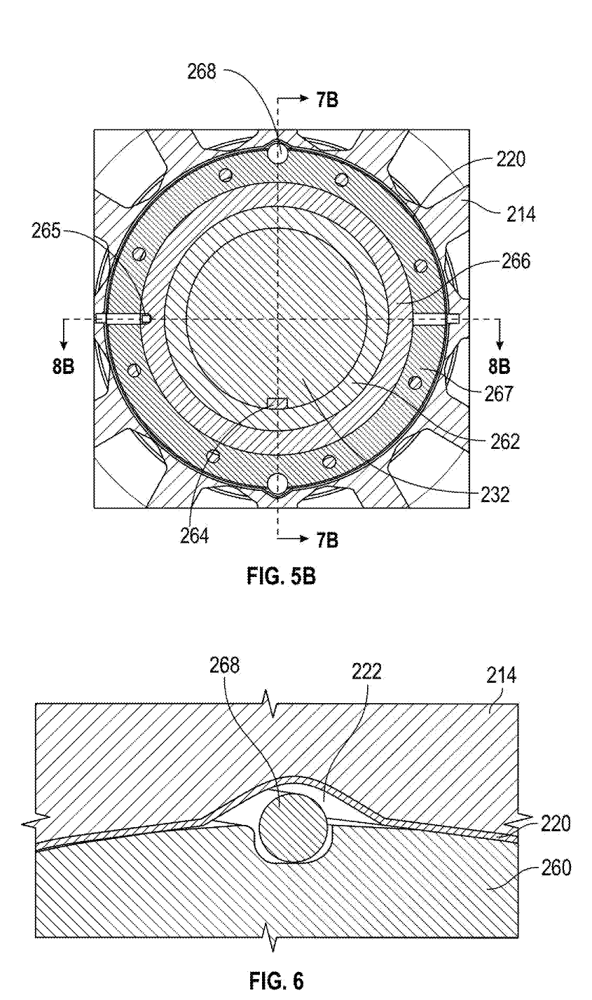

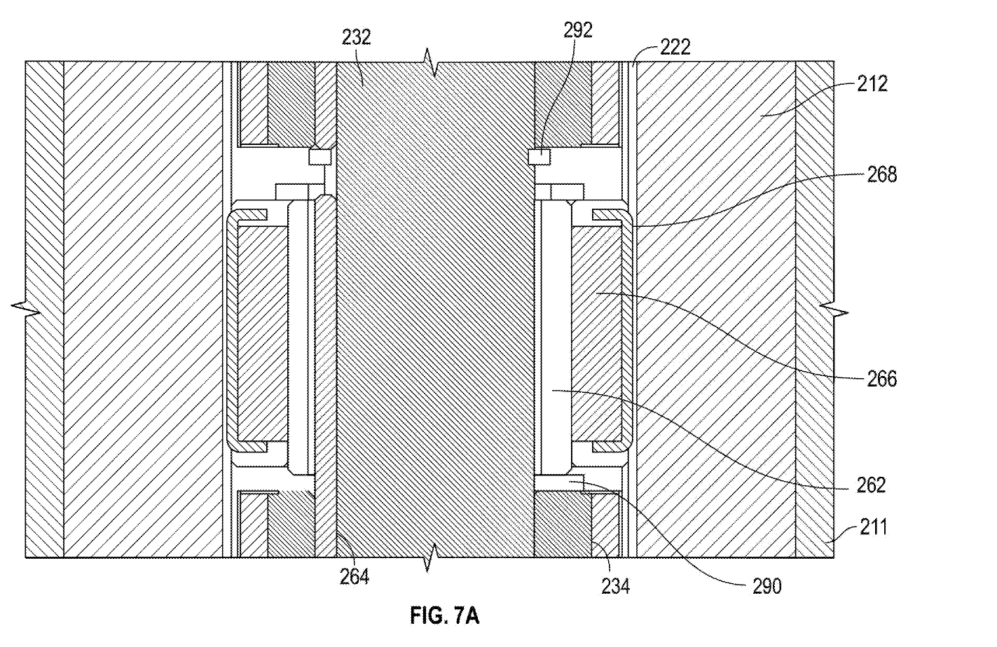

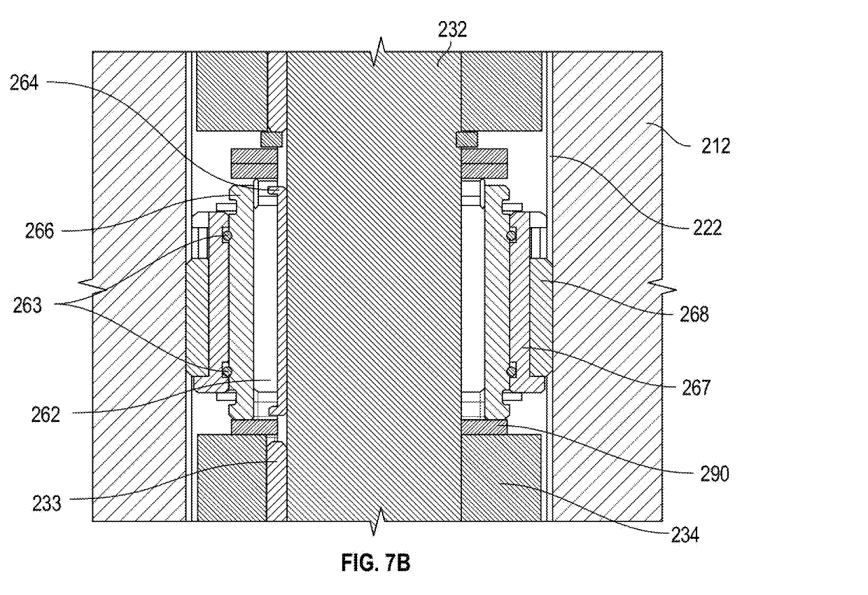

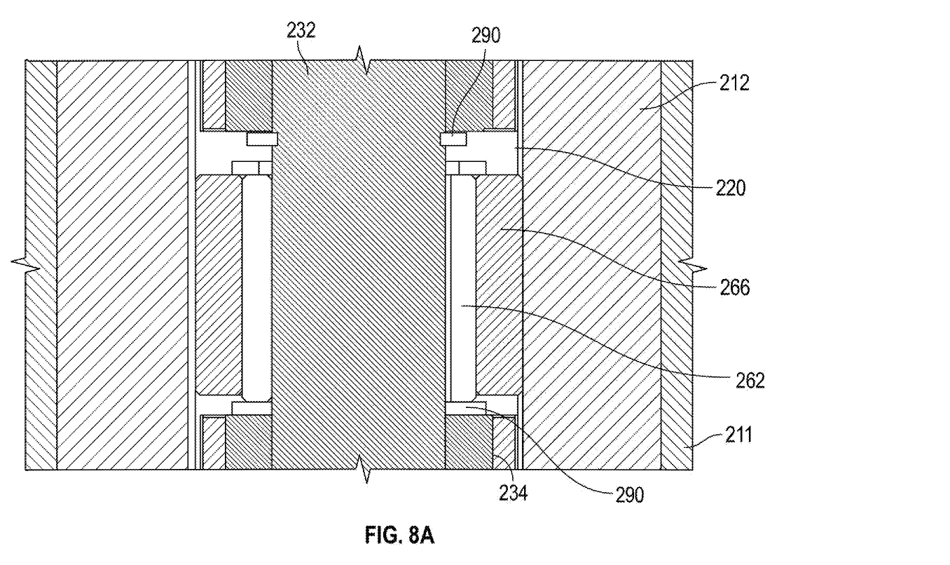

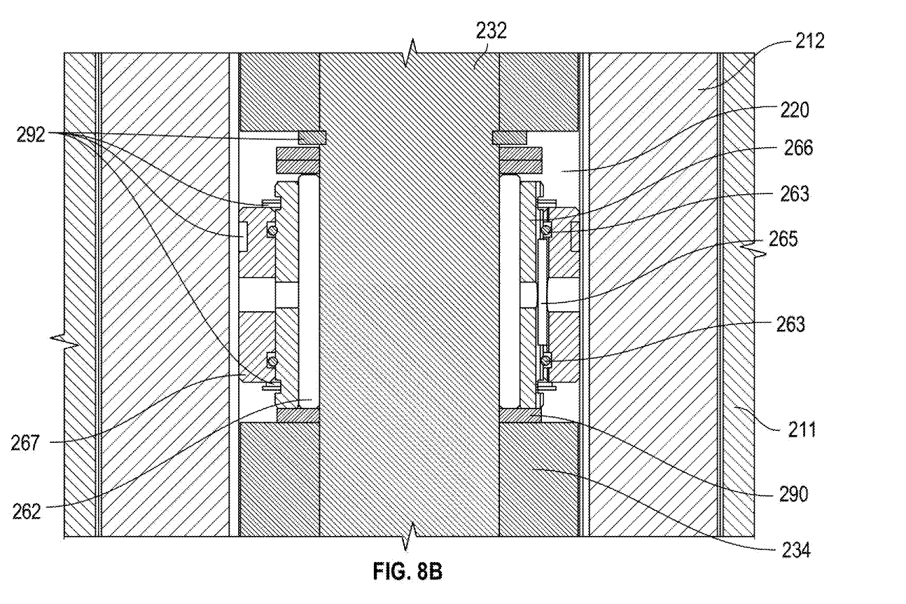

Each rotor bearing 260 includes a bearing sleeve 262, which is keyed to the shaft 232, for example via a shaft key 264, as shown in FIGS. 5A-5B and 7, a rotor bearing bushing 266 disposed circumferentially about and co-axial to the bearing sleeve 262, and a rotor bearing key 268. In some configurations, the rotor bearing key 268 is disposed on or about a radially outer surface of the rotor bearing bushing 266 or at least partially in a channel or groove formed in the radially outer surface of the rotor bearing bushing 266, as shown in FIG. 5A. In some configurations, for example as shown in FIG. 5B, the rotor bearing 260 includes a rotor bearing metallic carrier 267 disposed circumferentially about the bushing 266, and the rotor bearing key 268 is disposed on our about a radially outer surface of the carrier 267, for example, at least partially in a channel or groove formed in the radially outer surface of the carrier 267. A bushing anti-rotation key 265 can key or rotationally fix the bushing 266 to the carrier 267. One or more compliant bushing mounts 263 can be disposed radially between the bushing 266 and the carrier 267. A thrust washer 290 can be disposed axially between the rotor bearing 260 and the lower adjacent rotor section 234. A snap ring or retaining ring 292 may be disposed axially between the rotor bearing 260 and the upper adjacent rotor section 234.

At least a portion of the rotor bearing key 268 can extend longitudinally or axially parallel to the shaft 232. In some configurations, for example as shown in FIG. 7A, top and bottom end portions of the rotor bearing key 268 can be bent, for example at 90°, to help secure the rotor bearing key 268 to the rotor bearing bushing 266. The key 268 can be of a fixed type, which may require pre-alignment (before assembly of the shaft-rotor sub-assembly 230 with the canned stator) with the keyway 222 to properly engage the keyway 222. Alternatively, the key 268 can be a spring-loaded key, which may not require pre-alignment.

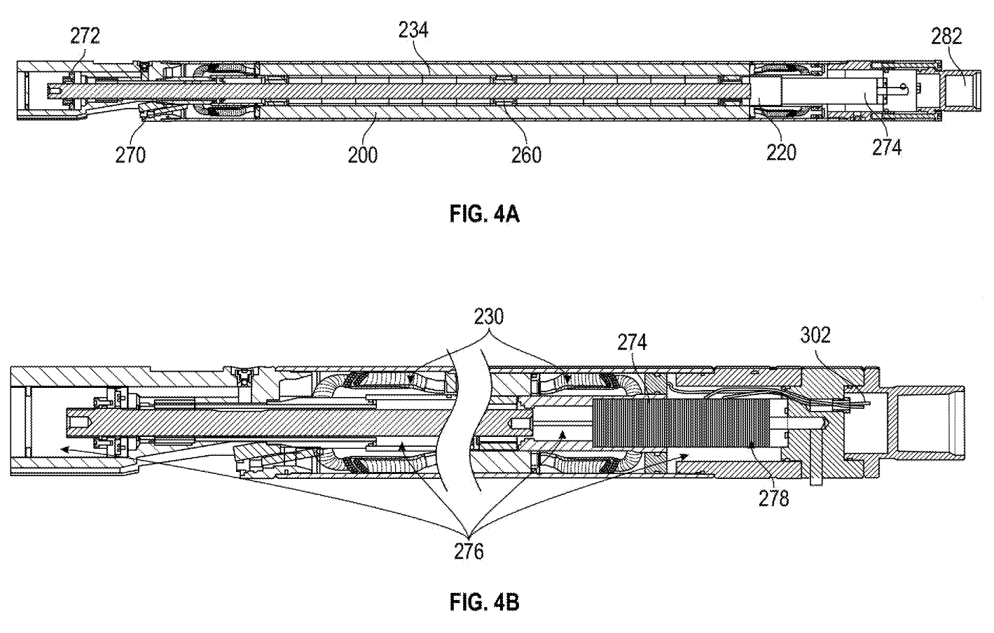

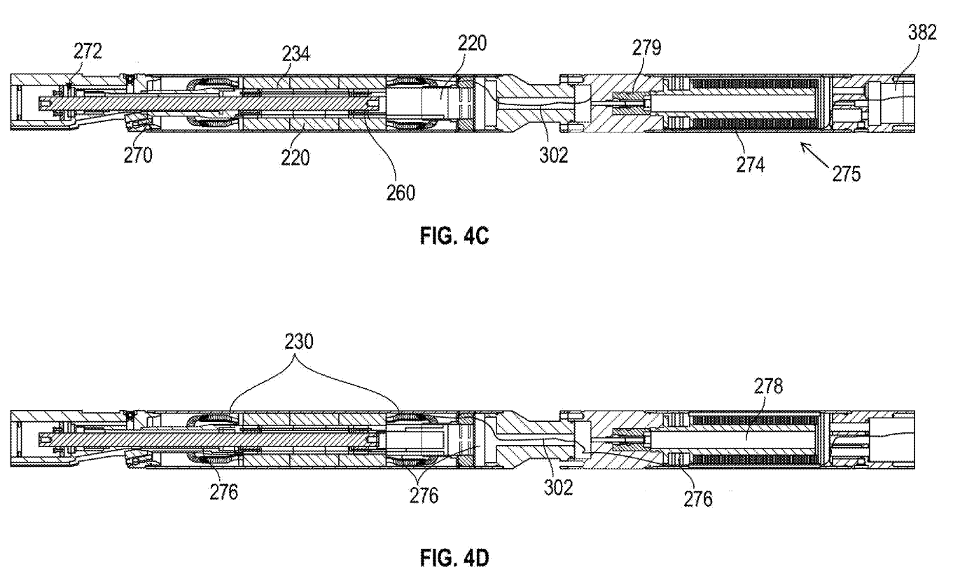

The shaft-rotor sub-assembly 230 is inserted into a central bore or cavity 250 of the canned stator 200 to form a canned motor assembly as shown in FIGS. 4A and 4C. In some configurations, the rotor bearing key 268 is pre-aligned and/or engaged with the stator 200 and/or can 220 keyway 222 before or as the shaft-rotor sub-assembly 230 is inserted into the cavity 250 of the canned stator 200. Engagement of the rotor bearing key 268 with the stator keyway 222, as shown in FIG. 6, provides an anti-rotation force and/or function for the rotor bearings 260. A canned stator according to the present disclosure can include various numbers of rotor bearing keys 268, for example two as shown, or more than two to increase the rotor bearing 260 mounting and retention if desired or required.

As canned stators according to the present disclosure include intermediate rotor bearings 260 that engage the stator keyway 222, the can 220 and intermediate rotor bearings 260 are directly supported on the stator inner diameter. In contrast, some existing canned motor architectures only include bearings 260 at the ends of the rotor, outside of the canned stator region. This can be a problem, particularly at high horsepower in oil wells, as the aspect ratio becomes too long for only top and bottom bearings 260. Enabling intermediate bearings 260 provides greater support, for example at higher horsepower and/or speed. Forming keyways 222 in the can 220 to follow keyways in the stator ID advantageously simplifies the assembly process and the number of intermediate parts, especially when manufacturing and assembling multiple motor sections. All of the motor sections can share the same shaft 232, winding, can 220, and stator, eliminating the need for any tandem or intermediate connection between sections.

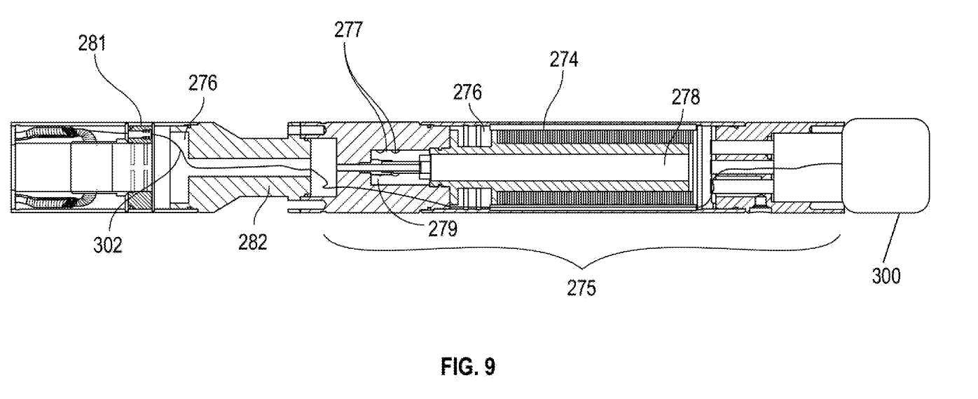

Various volumes or areas within the canned motor can be at least partially or fully filled or occupied by different materials or fluids. For example, as shown in FIGS. 4B and 4D, an encapsulation zone between the housing 211 and can 220 of the stator can be filled with encapsulation material 230. The encapsulation material 230 can fully fill in all gaps, for example, in the laminations 214, windings, pothead terminal, and/or lead wires. A dielectric oil zone, for example, in a mechanical gap between the stator can 220 and rotor 230, the volume within the head 270, at the area of the thrust bearing 272, and/or outside of a compensation bellow 274 at the bottom of the motor (if included), can be filled with dielectric oil 276. A well fluid zone inside the compensation bellow 274 can be filled with well fluid 278 and can advantageously allow for expansion and contraction of the motor oil 276. In some configurations, for example as shown in FIGS. 4C-4D, the compensation bellow 274 is disposed in a compensator unit 275 coupled to the remainder of the stator via a motor base 282. As shown in FIG. 9, the compensation unit 275 includes communication ports 277 that are open to the well bore, allowing well fluid to enter the inner bellow region and provide pressure equalization between the ESP motor and the wellbore. The bellow 274 is sealed, so the well fluid does not breach into the dielectric oil region. The compensation unit 275 can also include a pressure relief valve 279.

As also shown in FIGS. 4B, 4D, and 9, gauge connection and/or thermo couple wires 302 are disposed in the clean oil zone and are routed from the motor through the motor base 282 into an optional downhole gauge 300, which can be used for measurement of pressure, temperature, vibration, etc. In some configurations, for example as shown in FIG. 9, the stator 200 includes a bottom spacer 280, which may comprise, be part of, or work with the sealing mechanism to prevent fluid entry into the lamination stack 212. The sealing mechanism, for example, the spacer 280, includes one or more sealed ports 281 through which the wires 302 extend. The sealed ports ensure the clean dielectric oil does not enter the encapsulation zone and mix with the encapsulation material, while allowing the wires 302 to be sealed and routed through the motor base 282 to the compensator unit 275. Inside the compensator unit 275, the wires 302 are routed along the outer diameter of the bellow 274, and therefore immersed in dielectric oil, to the downhole gauge 300.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed

embodiments can be combined with, or substituted for, one another in order to form varying modes of the embodiments of the disclosure. Thus, it is intended that the scope of the disclosure herein should not be limited by the particular embodiments described above.

What is claimed is:

1. A motor for a submersible pumping system, the motor comprising:
a stator, including:
a lamination stack forming a central bore;
a lamination keyway recessed in the lamination stack at the central bore; and
a can disposed in the central bore, the can including a can keyway complementary to the lamination keyway, wherein the can keyway is hydroformed in-situ in the central bore; and
a rotor bearing inserted in the central bore, the rotor bearing including a key complementary to and inserted into the can keyway.

2. The motor of claim 1, wherein the lamination keyway and the can keyway extend along an axial length of the stator.

3. The motor of claim 1, wherein the rotor bearing includes an intermediate rotor disposed between an upper rotor bearing disposed proximate an upper end of the lamination stack, a lower rotor bearing disposed proximate a lower end of the lamination stack.

4. The motor of claim 1, wherein the rotor bearing includes a rotor bearing bushing, and wherein the key is disposed on an outer surface of the rotor bearing bushing.

5. The motor of claim 1, wherein the can keyway has a square cross-sectional shape.

6. The motor of claim 1, wherein the can keyway has a circular cross-sectional shape.

7. The motor of claim 1, wherein the can keyway extends along the lamination stack only proximate the rotor bearing.

8. The motor of claim 1, wherein the lamination stack is sealed at the can at an upper end and a lower end of the lamination stack.

9. The motor of claim 1, wherein the key extends lengthwise parallel to an axis of the rotor bearing.

10. The motor of claim 1, wherein the key is separately formed from the rotor bearing.

11. The motor of claim 10, wherein the key includes a top end and a bottom end, and wherein the top end and the bottom end are bent around the rotor bearing to secure the key to the rotor bearing.

12. The motor of claim 10, wherein the key is disposed in a groove on an outer surface of the rotor bearing.

13. The motor of claim 10, wherein the key is radially spring-loaded.

14. A stator for a submersible pumping system motor, the stator comprising:
a housing;
a plurality of stator laminations wound within the housing, the plurality of stator laminations forming a central bore extending therethrough, wherein the plurality of stator laminations include a recessed lamination keyway; and
a can disposed in the central bore, the can including a can keyway formed by hydroforming the can in-situ in the central bore of the plurality of stator laminations.

15. The stator of claim 14, wherein the can is sealed to the housing to form a canned stator sealed from ingress of external fluids.

16. A method of manufacturing a motor for a submersible pumping system, the method comprising:
inserting a can into a central bore of a stator, the stator comprising a lamination stack disposed within a housing, the lamination stack including a lamination keyway on an inner surface of the lamination stack;
when the can is inserted in the central bore, hydroforming a can keyway in the can, the can keyway hydroformed complementary to the lamination keyway;
aligning a key of a rotor bearing with the can keyway; and
inserting rotor bearing into the central bore such that the key is keyed in the can keyway.

17. The method of claim 16, wherein hydroforming the can keyway in the can includes hydroforming the can keyway with the lamination keyway directly as a mold for the can keyway.

18. The method of claim 16, further comprising sealing the lamination stack with the can to form a canned motor.

19. The method of claim 16, wherein the rotor bearing is an intermediate rotor bearing disposed between an upper rotor bearing and a lower rotor bearing.

20. The method of claim 19, wherein hydroforming the can keyway to the lamination keyway includes hydroforming the can keyway to the lamination keyway only proximate where the rotor bearing is disposed between the upper rotor bearing and the lower rotor bearing.
